(19) United States
(12) Patent Application Publication
(10) Pub. No.: US 2007/0270261 A1
(43) Pub. Date: Nov. 22, 2007

(54) Roller chain transmission device

(75) Inventors: Shunji Sakura, Osaka (JP); Akira Hirai, Osaka (JP); Toshihiko Aoki, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/804,673

(22) Filed: May 18, 2007

(30) Foreign Application Priority Data
May 22, 2006 (JP) 2006-141753

(51) Int. Cl. F16G 13/02; F16H 55/30

(52) U.S. Cl. 474/231; 474/152; 474/156

(57) ABSTRACT

In a roller chain transmission, the chain has rollers which are tapered from a central region toward their ends, and the teeth of the sprockets in driving and driven relationship with the chain have concave surfaces that contact the tapered parts of the rollers on both sides of a central region. However, there is no contact between the rollers and the sprockets in the central region. The central regions of the rollers can be provided with compressible external resin rings that cushion the impact on engagement of a roller with a sprocket tooth. Alternatively, each roller of the chain can be formed of two separate parts, and a compressible resin ring can be disposed between the two parts and enveloped by the two parts and a bushing surrounded by the roller parts

### CROSS-REFERENCE TO RELATED APPLICATION

This application claims priority on the basis of Japanese patent application 2006-141753, filed May 22, 2006. The disclosure of Japanese application 2006-141753 is hereby incorporated by reference.

### FIELD OF THE INVENTION

This invention relates to a roller chain transmission of the kind used in automobiles, industrial machines and the like. It relates more specifically to a roller chain transmission suitable for use in the timing drive of an automobile engine.

### BACKGROUND OF THE INVENTION

Roller chains exhibiting good performance under high loads, and at high speeds, and also exhibiting good resistance to wear elongation, have come into general use in power transmission mechanisms such as the timing drive of an automobile engine.

As shown in FIGS. 12 and 13, a conventional roller chain transmission includes a roller chain 510, in which cylindrical rollers 511 are rotatable on bushings 512, and the chain is in mesh with at least two sprockets similar to sprocket 520, one sprocket being a driving sprocket, and the other sprocket or sprockets being driven sprockets. The rollers of the chain engage teeth 521 of the sprockets.

The ends of the bushings 512, seen in FIG. 12, are press-fit into holes in inner plates 513. Connecting pins 514 extend through the bushings 512 with some play, and the ends of the pins are press-fit into pin holes 515a in outer plates 515. Thus, pairs of inner plates 513, and pairs of outer plates 515, are flexibly connected to one another by the connecting pins 514. The sequential engagement of the rollers of the chain with sprocket teeth 521 is shown schematically in FIGS. 13 and 14.

A typical roller chain of the kind described above is also shown in Japanese Patent Publication No. Sho 55-132442.

A conventional roller chain transmission is designed so that, at the start of engagement between a roller and a sprocket tooth, the roller engages with the sprocket tooth along an engagement line extending in the direction of the width of the sprocket tooth, the engagement line being perpendicular to the direction of advancement of the chain. Engagement of a roller 511 and a sprocket tooth 521 takes place instantaneously along the entire length of the engagement line. As a result, a large impact force is generated, resulting not only in in vibration and noise, but also in a significant loss of endurance of the transmission mechanism.

This invention solves the above-described problems of the conventional roller chain by suppressing the impact force generated at the start of the engagement between a roller and a sprocket tooth, thereby reducing engagement noise and significantly improving the endurance of a transmission mechanism.

### SUMMARY OF THE INVENTION

The roller chain transmission according to the invention comprises a roller chain having rollers, each rotatable on a bushing about an axis of rotation, and at least one sprocket having sprocket teeth engageable in driving relationship by the rollers of the roller chain. Each of the rollers has first and second, axially spaced, opposite ends, and a barrel-shaped outer circumferential surface in which the diameter of the outer circumferential surface gradually decreases, toward each of the opposite ends, from a central region between the opposite ends. The sprocket teeth have concave tooth surfaces, which are engageable with the outer circumferential surfaces of the rollers on both sides of the central regions of the rollers.

Preferably, when the concave tooth surface of each sprocket tooth is in contact with the outer circumferential surfaces of a roller, the central region of the barrel-shaped outer circumferential surface of the roller is out of contact with the concave tooth surface of the sprocket.

In one preferred embodiment, a resin ring surrounds the central region of the outer circumferential surface of each roller for reducing shock at the start of engagement of the roller with the sprocket tooth.

In another preferred embodiment, each roller comprises a first part extending from its central region to a first end thereof, and a second part extending from the central region to a second end thereof. The first and second parts are separate elements, each having a conical outer portion. The first and second parts of each roller and the bushing on which the roller is rotatable, envelop a resin ring which reduces shock at the start of engagement of the roller with a sprocket tooth.

Because of the barrel-like shape of the rollers, and the concave surfaces of the sprocket teeth in the widthwise direction, the impact force generated at the start of engagement between a roller and a sprocket tooth does not act only in the same direction as the direction of advancement of the roller chain. Instead, because of the shapes of the roller and the sprocket teeth, the impact force acts obliquely, and the component of the impact force acting in the direction of chain advancement is reduced. Consequently, vibration due to the impact force is suppressed, engagement noise is reduced, and, at the same time, the endurance of the transmission mechanism is improved.

The barrel-shaped rollers and the concave sprocket tooth surfaces also perform a guiding function, limiting lateral movement of the chain and maintaining it in centered relationship on the sprocket. As a result asymmetric, or one-sided, wear of the sprocket teeth, and asymmetric wear of the rollers due to biased contact with inner plates of the roller chain, are prevented. Consequently, the endurance of the sprocket and the chain are improved.

When the central regions of the rollers are prevented from contacting the surfaces of the sprocket teeth, the guiding and centering function of the rollers and sprocket teeth is better stabilized, and centering takes place more smoothly, further ensuring avoidance of asymmetric wear of the sprocket teeth.

When the central region of the barrel-shaped roller is surrounded by an outer ring of resin, engagement shock is further reduced, since the resin ring comes into contact with a sprocket tooth surface prior to contact between the outer circumferential surface of the roller and the sprocket tooth surface at the start of engagement. The resin ring functions as a cushion, absorbing and reducing the engagement impact force between the roller and the sprocket tooth, and further reducing engagement noise.

When the roller is divided into two separate parts, and an inner resin ring is enveloped by the separate parts of the two-part roller and the bushing, the inner resin ring functions as a cushion, absorbing and reducing compressive force in the axial direction of the roller, which is liable to occur at the time of engagement, and absorbs and reduces the impact force generated between the roller and the bushing, so that the endurance of the roller chain is significantly improved, and its useful life is extended.

### BRIEF DESCRIPTION OF THE DRAWINGS

FIG. 1 is a front elevational view of a roller chain transmission device according to the invention, including, as an auxiliary view, an enlarged side elevational view of a portion of the roller chain;

FIG. 2 is a schematic elevational view showing engagement between rollers and sprocket teeth in FIG. 1;

FIG. 3 is an exploded view of a portion of the roller chain according to a a first embodiment of the invention;

FIG. 4 is a perspective view schematically showing the engagement between rollers and sprocket teeth in the first embodiment;

FIG. 5 is a side elevational view showing the engagement between rollers and sprocket teeth in the first embodiment;

FIG. 6 is a cross-sectional view, taken on plane VI-VI in FIG. 5, including, as an auxiliary view, an enlargement showing details of the engagement between a roller and a sprocket;

FIG. 7 is a graph showing the results of noise measuring tests comparing the roller chain transmission of the first embodiment of the invention with a conventional roller chain transmission;

FIG. 8 is a perspective view schematically showing the engagement between rollers and sprocket teeth in a second embodiment of the invention;

FIG. 9 is a cross-sectional view of the roller in the second embodiment;

FIG. 10 is a perspective view schematically showing the engagement between rollers and sprocket teeth in a third embodiment of the invention;

FIG. 11 is a cross-sectional view of the roller in the third embodiment;

FIG. 12 is an exploded view of a portion of a conventional roller chain;

FIG. 13 is a side elevational view schematically showing engagement between rollers and sprocket teeth in a conventional roller chain transmission; and

FIG. 14 is across-sectional view taken on plane XIV-XIV in FIG. 13.

### DETAILED DESCRIPTION OF THE PREFERRED EMBODIMENT

The advantages of the roller chain transmission according to the invention, namely, the suppression of impact force and vibration, the reduction of engagement starting noise, and increased endurance, can be realized in various embodiments. In each embodiment, the rollers have a barrel-shaped outer circumferential surface, in which the diameter gradually decreases, from a central region toward the ends portions of the rollers, and the sprocket teeth have concave surfaces which engage the outer circumferential surfaces of the rollers on both sides of the central region.

The inner and outer plates of the chain can have any of various shapes, including, for example, a shape in which the intermediate region between the pin holes has parallel upper and lower edges, an oval shape having an expanded intermediate region, and a gourd-like shape having a pinched intermediate region. The sprocket can be made by any of various processes, including, for example, casting, sintering, and turning.

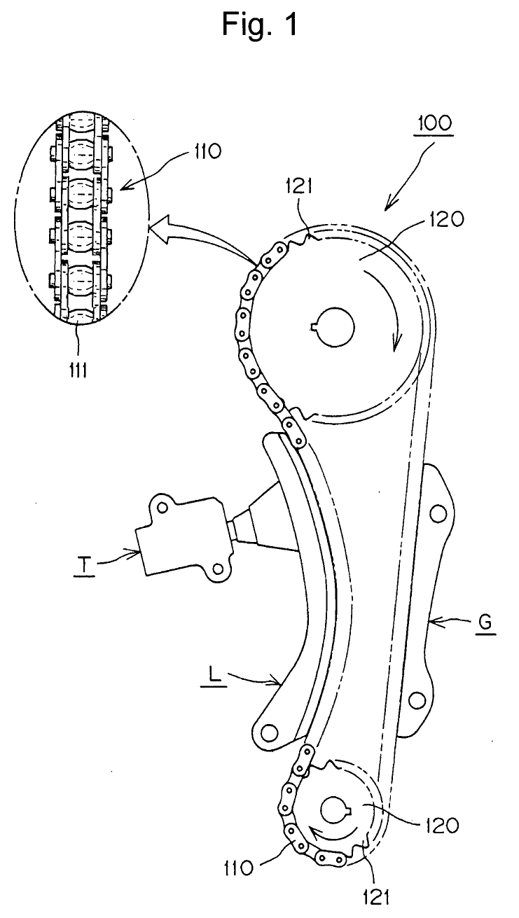

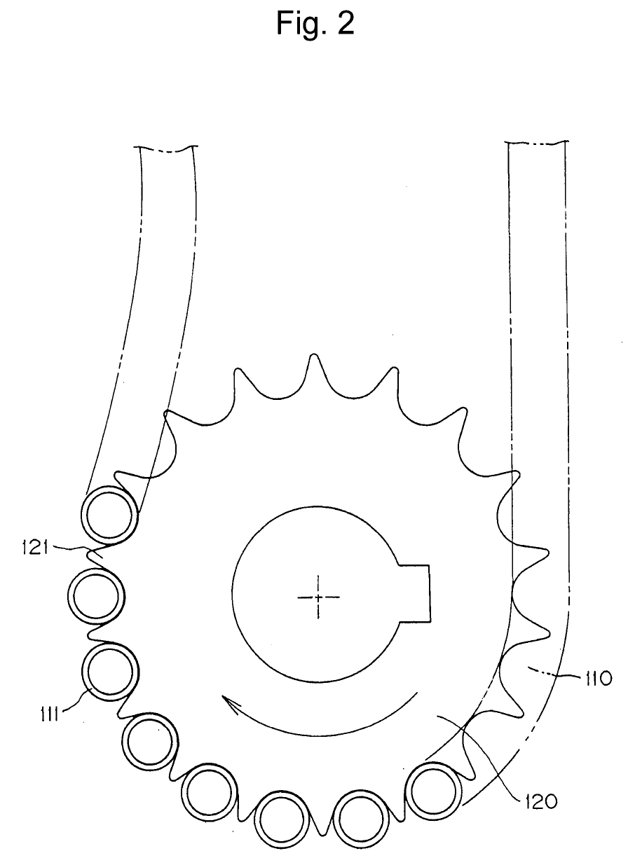

The transmission 100, as shown in FIGS. 1 and 2, is a timing drive for an automobile engine, and comprises a roller chain 110, having a number of rollers 111, and sprockets 120, each having a number of sprocket teeth. The smaller of the sprockets is typically secured to and driven by the engine crankshaft (not shown), and the larger sprocket is in driving relationship with a camshaft (not shown) for operating the intake and exhaust valves of the engine cylinders. The tension in the slack side of the chain, that is, the side traveling from the crankshaft sprocket toward the camshaft sprocket, is controlled by a pivoted tensioner lever L, biased against the chain by a tensioner T. The tension side of the chain, that is, the side traveling from the camshaft sprocket toward the crankshaft sprocket is guided by a guide lever G. The transmission, of course can have more than two sprockets. For example, in a dual overhead cam (DOHC) engine, a single chain, driven by a crankshaft sprocket, can drive two camshaft sprockets. In a V-type engine, it is common for four cams to be driven by a drive mechanism incorporating a plurality of roller chains.

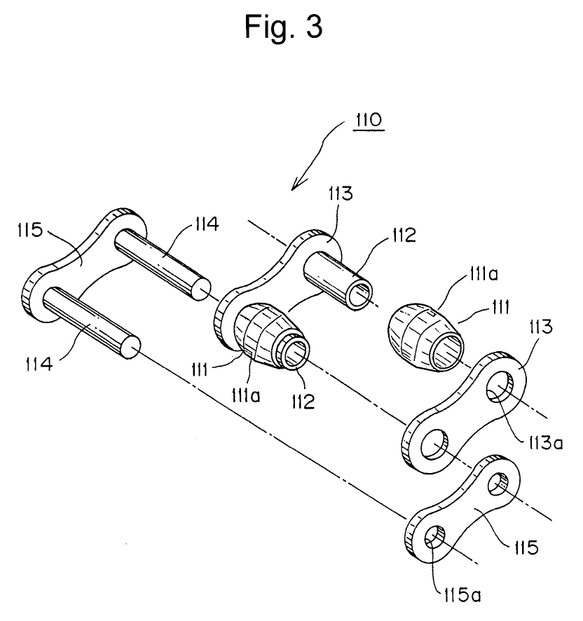

The construction of the links of the roller chain 110 is shown in FIG. 3. The rollers 111 are rotatable on bushings 112, which extend in pairs between right and left inner plates 113. The bushings are press-fit into bushing holes 113a in the inner plates 113. Connecting pins 114 extend through the bushings 112, and fit loosely in the bushings so that the bushings can rotate relative to the pins. Pairs of connecting pins 114 extend between right and left outer plates 115, and the ends of the pins press-fit into pin holes 115a in the outer plates. The chain 110 is formed so that the pairs of inner plates and the pairs of outer plates are disposed in alternating, overlapping, relationship along the length of the chain, and are connected by the pins and bushings in such a way that the chain is highly flexible in the plane of chain movement, but has a relatively low flexibility out of the plain of chain movement.

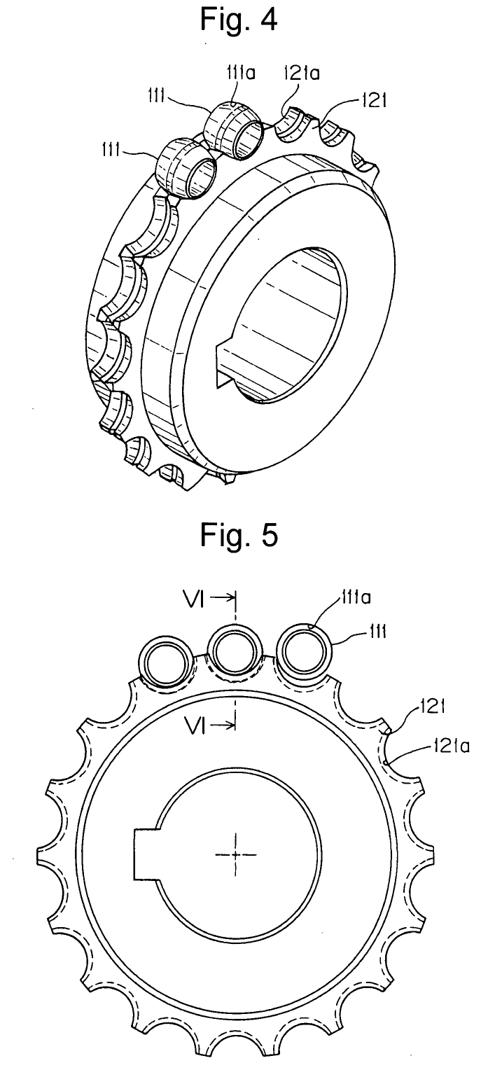

As shown in FIGS. 4-6, in which the connecting pins, the inner and outer plates, and the bushings, are omitted for the purpose of clear illustration, each of the rollers 111 has a barrel-shaped outer circumferential surface 111a, the diameter of which gradually decreases from a central region of the roller toward both ends of the roller. The teeth 121 of the sprocket 120 have surfaces 121a which are concave in the direction of the width of the teeth so that they are engageable with the convex outer circumferential surfaces of the rollers. Specifically, the surface 121a of each sprocket tooth is engageable with the tapered parts of the outer circumferential surfaces of a roller on both sides of the central region of the roller.

Because of the convex-concave relationship between the rollers and the sprocket teeth, the impact force generated at the start of engagement between a roller 111 and a sprocket tooth 121 does not act only along the direction of advancement of the chain. Instead, the impact forces act in two directions both of which are oblique with respect to the plane of movement of the chain. Consequently, the impact force is distributed, and vibration due to impact forces on engagement with of the rollers with the sprocket teeth is suppressed.

The sprocket tooth surfaces 121a also exert centering action on the rollers 111 guiding the chain toward the centers of the sprocket teeth and limiting lateral snaking movement of the chain due to chain tension. Consequently, biased, i.e., one-sided, wear of the sprocket teeth 121 is prevented. The centering action also prevents biased wear of a roller due to preferential contact with one of the two inner plates by which the roller is confined.

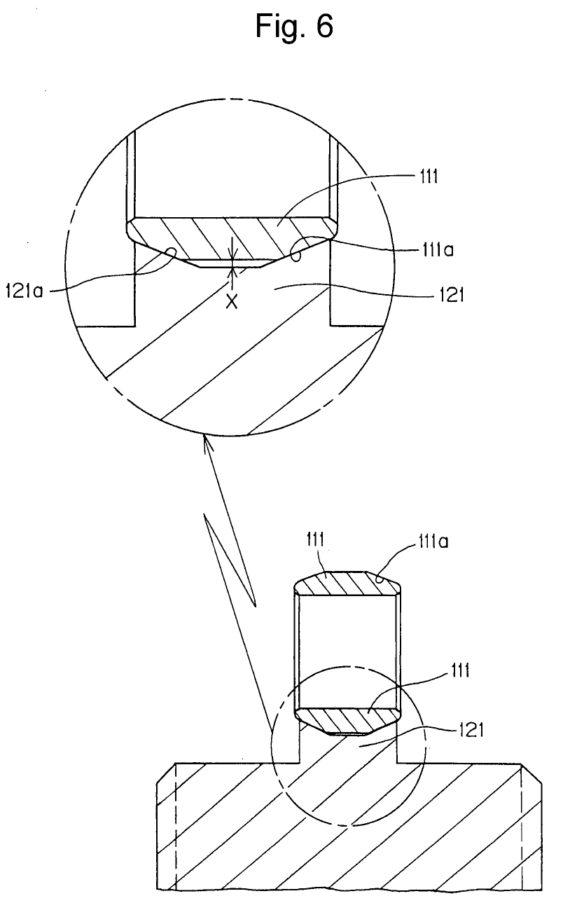

As shown in FIG. 6, the outer circumferential surface 111a of the roller 111 and the sprocket tooth surface 121a are formed so that there is a gap X between the two surfaces at the central region of the roller, and the roller contacts the sprocket tooth on both sides of the central region but not within the central region. In the case shown in FIG. 6, the cross-sectional shape of the outer circumferential surface of the roller consists of two oppositely sloping, straight, conical portions and a cylindrical central portion, coaxial with the inner surface of the roller, and connecting the two conical portions. The cross-sectional shape of the sprocket tooth is similar, consisting of two conical surfaces that conform to the conical surfaces of the roller, and a cylindrical connecting surface. The gap X results from the fact that the connecting cylinder of the roller is longer than the connecting cylinder of the tooth. Of course, the shapes of the tapered surfaces of the roller and the sloping surfaces of the sprocket tooth need not be straight. However, the sloping surfaces of the roller preferably conform to the sloping surfaces of the sprocket teeth so that mutual contact takes place over a substantial area. Moreover, the gap need not be formed by opposed cylindrical surfaces. For example, the gap can be formed by grooves provided in the central region of the roller, or in the central region of the sprocket tooth, or both.

The presence of the gap X improves the cooperation of the barrel-shaped surface of the roller with the sprocket tooth surface 121a so that the centering function is achieved smoothly and in a stable manner, and asymmetric wear of the sprocket and the rollers is avoided.

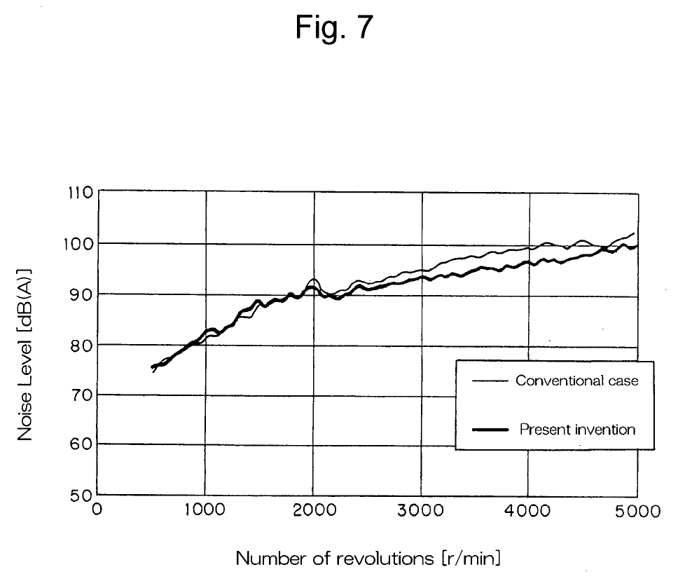

The noise measurements depicted in FIG. 7 were made using a transmission having the construction depicted in FIGS. 1-6 and a conventional transmission having the same chain pitch, and the same number of sprocket teeth. The noise measuring test was made by gradually increasing the rotating speeds of the chain driving sprocket from 500 rpm to 5000 rpm, measuring the overall noise level at a position 100 mm in front of the roller chain 100 and plotting the noise level against the sprocket rotation speed. “Order sound,” i.e., the predominant sound generated by a chain transmission was also measured at its primary frequency. The order sound is related to the number of teeth and the sprocket rotation speed.

As is apparent from FIG. 7, at rotation speeds above about 2000 rpm, which is a typical steady-state region, the overall noise value for the chain according to the invention was several dB below the noise value for the conventional roller chain transmission.

In the roller chain transmission according to the invention, since the impact force generated at the start of engagement between a roller 111 and a sprocket tooth 121 does not act only in the direction of advancement of the roller chain, but instead acts obliquely as a result of the barrel shape of the roller and the concave shape of the sprocket tooth, the engagement impact force and vibration are suppressed. As a result, the noise generated by the transmission is reduced, and the endurance of the transmission mechanism is improved. Furthermore, since the sprocket tooth surfaces 121a exert a centering action on the rollers 111 one-sided wear of the sprocket teeth 121 is prevented so that the endurance of the sprocket 120 is improved. Biased wear of the rollers 111, resulting from one-sided contact with the inner plates 113 of the chain is also prevented

When the outer circumferential surfaces of the barrel-shaped rollers and the sprocket tooth surfaces are formed so that they do not contact each other at their respective central regions, the sprocket tooth exerts a centering function in a stable manner, further suppressing one-side wear of the sprocket teeth and of the rollers.

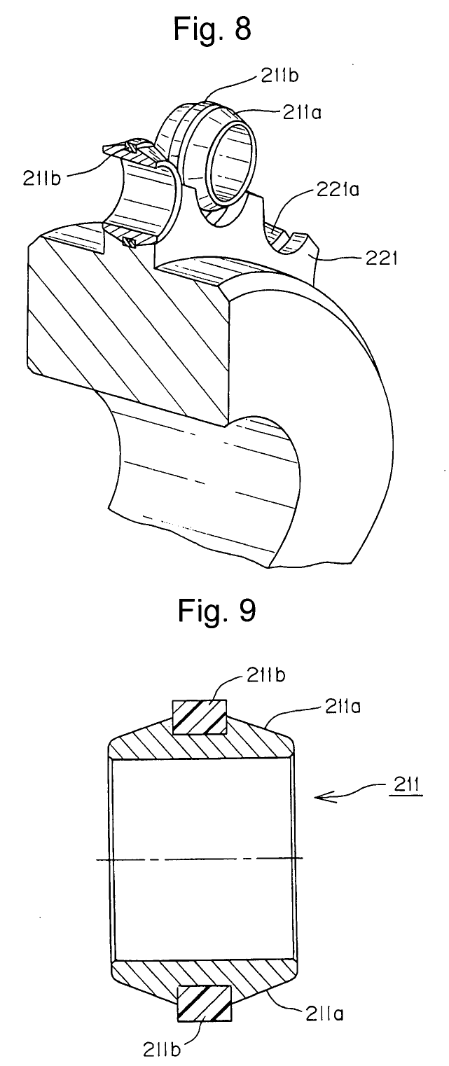

In a second embodiment of the roller chain transmission, shown in FIGS. 8 and 9, the form of the roller 211 is different from that of the roller 111 in the first embodiment shown in FIGS. 1-6. Features of the second embodiment that are substantially the same as features of the first embodiment are numbered with reference numbers that exceed by one hundred the reference numbers of corresponding features of the first embodiment.

The rollers 211 are barrel-shaped rollers, each having an outer circumferential surface 111a the diameter of which gradually decreases from a central region toward both ends of the roller. The sprocket teeth 221 have tooth surfaces 221a, which are concave in the direction of the width of the teeth so that they are engageable with the convex outer circumferential surfaces of the rollers. Specifically, the surface 221a of each sprocket tooth is engageable with the tapered parts of the outer circumferential surfaces 211a of a roller on both sides of the central region of the roller. As in the first embodiment, the impact force acts in directions oblique with respect to the plane of movement of the chain. Consequently, the impact force is distributed, and vibration due to impact forces on engagement with of the rollers with the sprocket teeth is suppressed. The sprocket tooth surfaces also act to center the rollers, thereby avoiding one-sided wear of the sprocket teeth and of the rollers.

The rollers 211 differ from the rollers 111 of the first embodiment in that their central regions are fitted with resin rings 211b. These resin rings are preferably seated in centrally located annular grooves formed in the outer circumferential surfaces of the rollers, and protrude by a distance sufficient to reach the central parts of the sprocket teeth. Thus, at the start of engagement of a ring with a sprocket tooth 221, the resin ring 211b comes into contact with a sprocket tooth before the tapered surfaces 211a of the roller come into contact with the sprocket tooth surface 221a. The resin ring 211b therefore functions as a cushion, absorbing shock and reducing the engagement impact force acting between the roller and the sprocket tooth 221.

The transmission of the second embodiment exhibits all of the advantages of the transmission of the first embodiment, and, in addition, by virtue of the cushioning action of the resin ring, reduces the shock occurring at the start of engagement of the rollers with the sprocket teeth, thereby achieving a further reduction in the engagement impact force and a further reduction in noise.

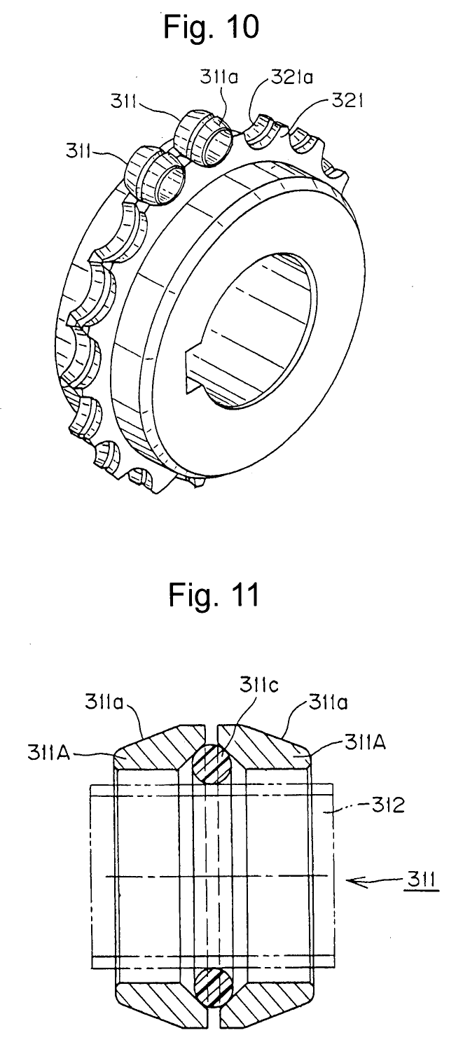

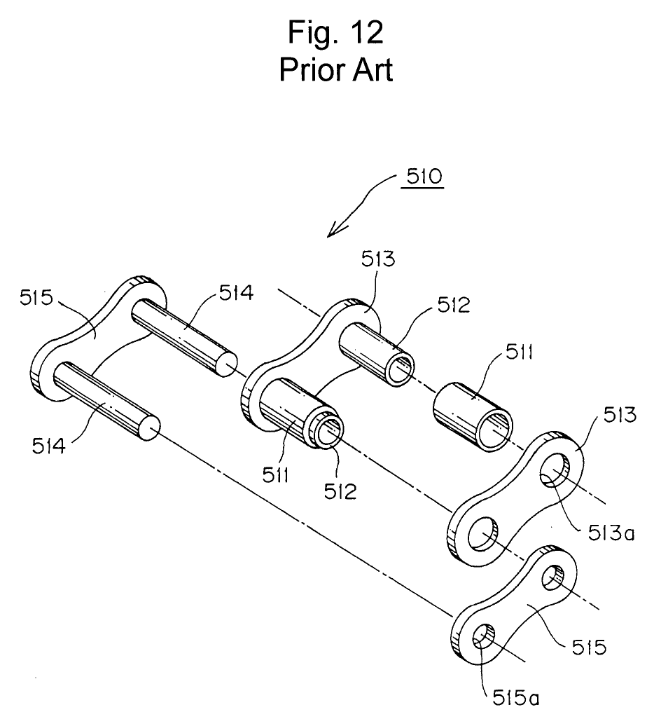

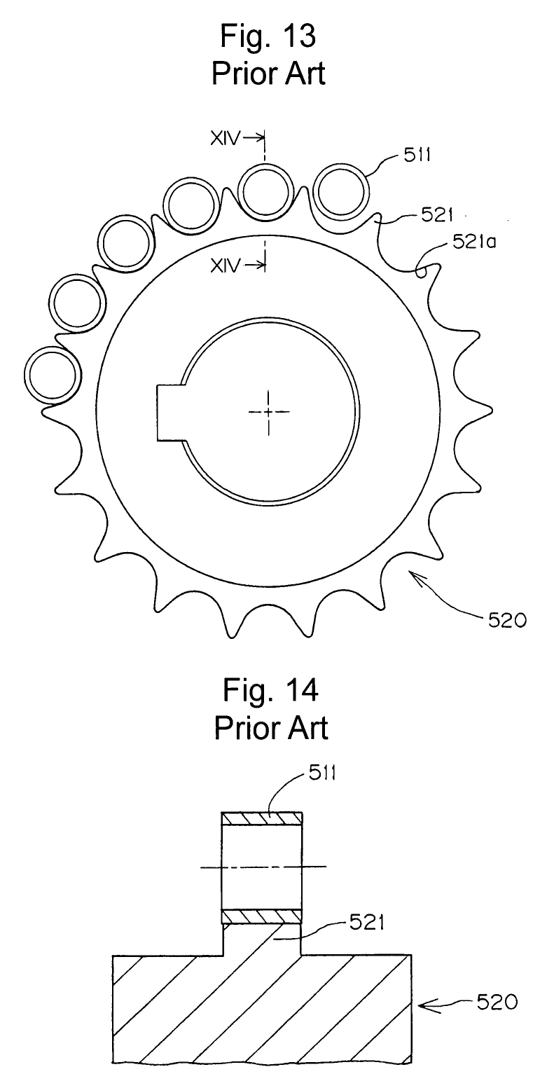

In a third embodiment of the roller chain transmission, shown in FIGS. 10 and 11, the form of the roller 311 is different from that of the rollers 111 and 211 in the first and second embodiments. Features of the third embodiment that are substantially the same as features of the first embodiment are numbered with reference numbers that exceed by two hundred the reference numbers of corresponding features of the first embodiment.

The roller 311 comprises a pair of separate, right and left, conical roller parts 311A, which are spaced from each other, and a resin ring 311c, which is sandwiched between the two roller parts and enveloped by the roller parts and a bushing 312. The resin ring is disposed between, and in contact with, conical inner surfaces of the roller parts 311A, and also in contact with the cylindrical outer surface of bushing 312. The ring maintains the roller parts separated from each other, but, because it has some compressibility, it acts as a cushion, allowing the roller parts to move toward each other, and also allowing the roller parts to move toward the bushing.

When the roller comes into contact with a sprocket tooth, the contact between the tapered parts of the roller and the concave sprocket tooth surface causes the roller parts to move toward each other, compressing the ring 311c. A part of the ring is also compressed by radial movement of the roller parts toward the bushing on impact. The compression of the ring 311c absorbs the impact force, and reduces the shock of the engagement of the roller with a sprocket tooth 321.

The transmission of the third embodiment exhibits all of the advantages of the transmissions of the first and second embodiments. In addition, by virtue of the disposition of the resin ring between separate roller parts, and the fact that the resin ring is enveloped by the roller parts and the bushing, the transmission of the third embodiment reduces the impact force generated between the roller and the bushing, thereby achieving a further reduction in noise, and a still further improvement in the endurance of the roller chain.

We claim:

1. A roller chain transmission comprising a roller chain having rollers each rotatable on a bushing about an axis of rotation, and at least one sprocket having sprocket teeth engageable in driving relationship by the rollers of the roller chain, in which;
each of said rollers has first and second, axially spaced, opposite ends, and a barrel-shaped outer circumferential surface in which the diameter of the outer circumferential surface gradually decreases, toward each of said opposite ends from a central region between said opposite ends; and
said sprocket teeth have concave tooth surfaces, which are engageable with the outer circumferential surfaces of the rollers on both sides of the central regions of the rollers.

2. A roller chain transmission device according to claim 1, in which each roller comprises a first part extending from said central region to said first end thereof, and a second part extending from said central region to said second end thereof, the first and second parts being separate elements, each having a conical outer portion, and in which the first and second parts of each roller and the bushing on which the roller is rotatable envelope a resin ring for reducing shock at the start of engagement of the roller with a sprocket tooth.

3. A roller chain transmission according to claim 1, in which, when the concave tooth surface of each sprocket tooth is in contact with the outer circumferential surfaces of a roller, the central region of the barrel-shaped outer circumferential surface of the last-mentioned roller is out of contact with the last-mentioned concave tooth surface of the sprocket.

4. A roller chain transmission device according to claim 3, in which each roller comprises a first part extending from said central region to said first end thereof, and a second part extending from said central region to said second end thereof, the first and second parts being separate elements, each having a conical outer portion, and in which the first and second parts of each roller and the bushing on which the roller is rotatable envelope a resin ring for reducing shock at the start of engagement of the roller with a sprocket tooth.

5. A roller chain transmission device according to claim 1, including a resin ring surrounding the central region of the outer circumferential surface of each roller for reducing shock at the start of engagement of the roller with the sprocket tooth.
